(19) United States
(12) Patent Application Publication
(10) Pub. No.: US 2008/0054739 A1
(43) Pub. Date: Mar. 6, 2008

(54) Generator-starter arrangement for a gas-turbine engine

(76) Inventor: Rudolf Lueck, Rehbrucke (DE)

Correspondence Address: Harbin King & Klima, 500 Ninth Street SE, Washington, DC, 20003, US

(21) Appl. No.: 11/896,506

(22) Filed: Sep. 4, 2007

(30) Foreign Application Priority Data
Sep. 1, 2006 (DE) 10 2006 041 323.7

(51) Int. Cl. F02C 7/26; H02K 7/00; H02K 9/02

(52) U.S. Cl. 310/58; 60/786

(57) ABSTRACT

With a generator-starter arrangement for a gas-turbine engine to supply the aircraft with electric power and to start the engine, the rotor (18) of the generator or starter, respectively, is formed by one of the rotors (4) of the high-pressure compressor (1) of the engine, which is provided with magnets (12) on individual blade tips, with the high-pressure compressor being surrounded in this area by a stator (17) of the generator or the starter, respectively. Such a generator-starter arrangement enables a high power requirement of the aircraft to be met, without causing stability or weight problems on the engine. In addition, the arrangement is easily accessible for maintenance and repair.

This application claims priority to German Patent Application DE 10 2006 041 323.7 filed Sep. 1, 2006, the entirety of which is incorporated by reference herein.

The present invention relates to a generator-starter arrangement for a gas-turbine engine, which comprises a stator including annularly disposed electric coils and a rotor provided with magnets and connected to the high-pressure shaft of the engine.

Electric power for aircraft use is normally taken off the engine by way of a generator connected via a radial drive shaft to the high-pressure shaft, with this generator also being used as starter for the engine. While this principle has proved to be satisfactory up to a certain amount of power off-take, it is problematic for aircraft with very high power requirement, for example more than 1000 kW/engine, in that the compressor encounters stability problems and the increased weight of the generator or starter, respectively, affects the weight distribution of the engine. In addition, the radial drive shaft and the appertaining gearwheel are expensive in terms of design and heavy. The so-called embedded generators are further disadvantageous in that they entail considerable assembly, maintenance and repair effort.

The present invention, in a broad aspect, provides for a generator-starter arrangement for a gas-turbine engine, which enables a high power off-take for the aircraft, while keeping the design, assembly and maintenance effort low.

The present invention provides for one of the rotors of the high-pressure compressor to be designed as the rotor of the generator or the starter motor, respectively. For this purpose, magnets are provided on certain blade tips of the respective compressor rotor, with the high-pressure compressor being surrounded in this area by a stator consisting of a ferro-magnetic iron ring equipped with electric coils. Co-axial arrangement and integration into the high-pressure compressor enable the generator to be designed for high power off-take without causing weight or weight distribution problems, in particular since the heavy and complex drive shaft and gearbox normally required are dispensed with. A further advantage of the inventive generator-starter arrangement over the so-called embedded generator is its ease of access for repair and maintenance purposes.

The present invention is more fully described in light of the accompanying drawing showing a preferred embodiment.

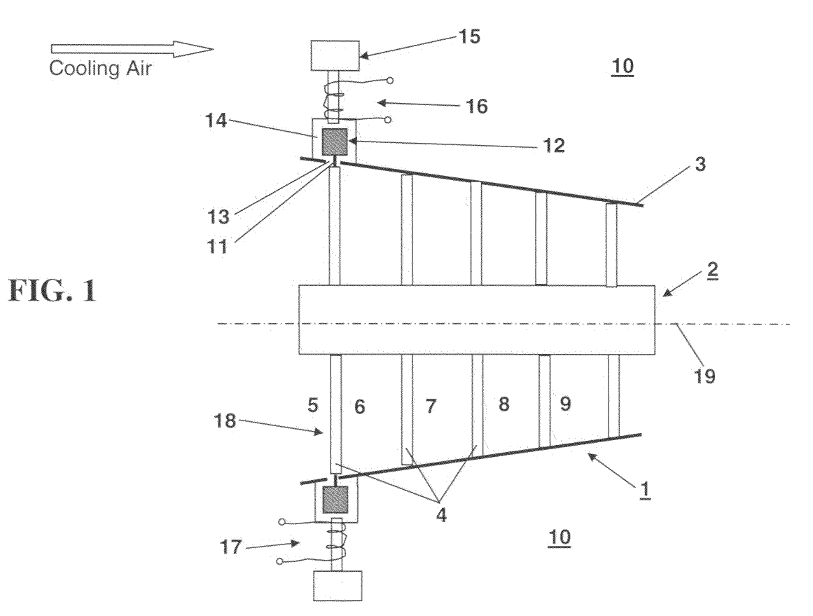

FIG. 1 schematically shows a section of a generator-starter arrangement in connection with the compressor of an aircraft gas turbine.

FIG. 1 schematically shows a multi-stage high-pressure compressor 1 of which, for simplicity, only the compressor rotors 4 of the first to the fifth compressor stage 5 to 9 are illustrated, these being connected to the high-pressure shaft 2 and surrounded by a casing 3 and consisting of rotor disks to which compressor blades are fitted. The casing 3 is surrounded by a bypass duct 10 which is flown by cooling air. A magnet 12 is attached—via a fin 11—to individual compressor blades of the compressor rotor 4 of the first compressor stage 5. The magnets 12, which are permanent magnets or electromagnets, are regularly spaced on the periphery of the compressor rotor 4 and, since the fins 11 protrude through a slot 13 in the casing 3, move within the bypass duct 10, in fact protected in an annular chamber 14 provided on the outer periphery of the casing 3. One or more magnets 12 can be attached to each individual compressor blade, or some compressor blades can have the magnets omitted, in a balance manner. The magnets 12 can be attached to the compressor rotor via an alternative structure, such as a ring attached to and surrounding the compressor blades. The compressor rotor 4, together with the magnets 12, forms the rotor 18 of the generator-starter arrangement. A stator 17 formed by a ferro-magnetic iron ring 15 to which electric coils 16 are fitted at regular intervals surrounds the first compressor stage 5 remote of the magnets 12 or the annular chamber 14, respectively. For ease of assembly and maintenance, the iron ring 15 includes two or more segments.

Thus, a generator for the production of electric power which is driven by the high-pressure shaft 2 and the high-pressure compressor 1 plus a motor for starting the engine which drives the high-pressure shaft 2 via the high-pressure compressor 1 are available. In the generator mode, a pulsating direct voltage is tapped upon rectification of the voltage generated in the electric coils 16. If used as motor (starter), the electric coils 16 are connected via power electronics to a power source to start the engine.

The co-axial arrangement coupled to a compressor rotor, with the center of gravity lying in the engine axis 19, enables the above-described generator or starter, respectively, to be designed and dimensioned in correspondence with the requested high aircraft power off-take without causing weight or weight distribution problems resulting from such increased power off-take. In addition, the heavy and complex drive shaft and the large gearwheel required in the state-of-the art are dispensed with. The generator-starter arrangement is easily accessible for maintenance and repair. The air flowing in the bypass duct can favorably be used for cooling the generator.

In an alternative embodiment, the magnets can be positioned on more than one compressor rotor, and associated with corresponding stator arrangements for increasing the electrical output and/or distributing the load between multiple compressor rotors.

### LIST OF REFERENCE NUMERALS

1 High-pressure compressor

2 High-pressure shaft

3 Casing

4 Rotors

5-9 First to fifth compressor stages

10 Bypass duct

11 Fin

12 Magnet

13 Slot in casing 3

14 Annular chamber

15 Ferro-magnetic iron ring

16 Electric coils

17 Stator

18 Rotor

19 Engine axis

What is claimed is:

1. A generator-starter arrangement for a gas-turbine engine, comprising:
a stator having a plurality of circumferentially disposed electric coils; and
a rotor having a plurality of circumferentially positioned magnets and connected to a high-pressure shaft of the engine, the rotor being formed by a compressor rotor of a high-pressure compressor of the engine, with the plurality of magnets being attached to certain blade tips of the compressor rotor, the compressor rotor being at least partially surrounded by the stator.

2. A generator-starter arrangement in accordance with claim 1, and further comprising a plurality of fins by which the magnets are connected to a plurality of compressor blade tips, respectively, the fins protruding through a slot in the casing of the high-pressure compressor, with the magnets and the stator being positioned in a bypass duct surrounding the high-pressure compressor to be cooled by air flow through the bypass duct.

3. A generator-starter arrangement in accordance with claim 2, and further comprising an annular chamber connected to the outside of the casing in which the plurality of magnets is positioned to rotate in a protected manner.

4. A generator-starter arrangement in accordance with claim 3, wherein the rotor is formed by the first compressor stage rotor.

5. A generator-starter arrangement in accordance with claim 4, wherein the stator includes a ferro-magnetic ring operatively associated with the electric coils, the ferro-magnetic ring being positioned adjacent the plurality of magnets and being formed from a plurality of individual segments.

6. A generator-starter arrangement in accordance with claim 5, wherein the magnets are permanent magnets.

7. A generator-starter arrangement in accordance with claim 5, wherein the magnets are electromagnets.

8. A generator-starter arrangement in accordance with claim 3, wherein the rotor is formed by one of the second through fifth compressor stage rotors.

9. A generator-starter arrangement in accordance with claim 1, and further comprising an annular chamber connected to the outside of the casing in which the plurality of magnets is positioned to rotate in a protected manner.

10. A generator-starter arrangement in accordance with claim 1, wherein the rotor is formed by the first compressor stage rotor.

11. A generator-starter arrangement in accordance with claim 1, wherein the rotor is formed by one of the second through fifth compressor stage rotors.

12. A generator-starter arrangement in accordance with claim 1, wherein the stator includes a ferro-magnetic ring operatively associated with the electric coils, the ferro-magnetic ring being positioned adjacent the plurality of magnets and being formed from a plurality of individual segments.

13. A generator-starter arrangement in accordance with claim 1, wherein the magnets are permanent magnets.

14. A generator-starter arrangement in accordance with claim 1, wherein the magnets are electromagnets.

15. A generator-starter arrangement in accordance with claim 2, wherein the stator includes a ferro-magnetic ring operatively associated with the electric coils, the ferro-magnetic ring being positioned adjacent the plurality of magnets and being formed from a plurality of individual segments.

16. A generator-starter arrangement in accordance with claim 15, wherein the magnets are permanent magnets.

17. A generator-starter arrangement in accordance with claim 15, wherein the magnets are electromagnets.

18. A generator-starter arrangement in accordance with claim 1 and further comprising:
a second stator having a plurality of circumferentially disposed electric coils; and
a second rotor having a plurality of circumferentially positioned magnets and connected to the high-pressure shaft of the engine, the rotor being formed by a further compressor rotor of the high-pressure compressor of the engine, with the plurality of magnets being attached to certain blade tips of the further compressor rotor, the compressor rotor being at least partially surrounded by the stator.
